(19) United States
(12) Patent Application Publication
(10) Pub. No.: US 2024/0086883 A1
(43) Pub. Date: Mar. 14, 2024

(54) PRODUCT INFORMATION PROCESSING APPARATUS

(71) Applicant: NEC Corporation, Minato-ku, Tokyo (JP)

(72) Inventor: Shozo Fujino, Tokyo (JP)

(73) Assignee: NEC Corporation, Minato-ku, Tokyo (JP)

(21) Appl. No.: 18/271,165

(22) PCT Filed: Jan. 12, 2021
(86) PCT No.: PCT/JP2021/000627

§ 371 Date: Jul. 6, 2023

(51) Int. Cl. G06Q 20/20; G07G 1/01

(52) U.S. Cl. CPC G06Q 20/20; G07G 1/01

(57) ABSTRACT

A product information processing apparatus (10) is used in a state of being arranged between a salesperson who performs purchase processing of a product and a customer who purchases the product. In an example illustrated in the present figure, the product information processing apparatus (10) is placed on a support member (20) for purchasing a product. The support member (20) is, for example, a counter. The salesperson and the customer are opposed to each other with the support member (20) interposed therebetween. The product information processing apparatus (10) includes an input/output unit (140). The input/output unit (140) performs at least one of input and output of information relating to a product. In addition, the input/output unit (140) is oriented in a direction different from the salesperson and the customer in planar view.

### TECHNICAL FIELD

The present invention relates to a product information processing apparatus.

### BACKGROUND ART

A product information processing apparatus such as a POS terminal is provided in a store selling a product. The product information processing apparatus includes a product information reading apparatus reading information (for example, a barcode or a two-dimensional code) from a product and a printing apparatus printing a receipt or the like.

On the other hand, in recent years, it is being considered that both a salesperson and a customer are allowed to operate a product information processing apparatus. Patent Document 1 describes a POS terminal apparatus in which a register part is made rotatable relative to a pedestal part. By making so, an orientation of the register part can be varied between when a salesperson operates the POS terminal apparatus and when a customer operates the POS terminal apparatus.

### RELATED DOCUMENT

### Patent Document

Patent Document 1: Japanese Patent Application Publication No.

2010-020370

### SUMMARY OF INVENTION

### Technical Problem

The present inventor has considered facilitating handling of a product information processing apparatus for both a salesperson and a customer by devising a layout of members constituting the product information processing apparatus, even without changing an orientation of the product information processing apparatus.

One example of an object of the present invention is to facilitate handling of a product information processing apparatus for both a salesperson and a customer.

### Solution to Problem

According to the present invention, provided is a product information processing apparatus being installed in a store, being used in a state of being arranged between a salesperson who performs purchase processing of a product and a customer who purchases the product, and performing processing relating to purchase of a product, the product information processing apparatus including
an input/output unit that is oriented in a direction different from the salesperson and the customer in planar view, and performs at least one of input and output of information relating to a product.

According to the present invention, provided is a product information processing apparatus including:
a plurality of input/output areas being provided in order to perform at least one of input and output of information relating to a product, and including a transmission area through which an electromagnetic wave is transmitted or an opening; and
an arrangement area being provided in association with each of the plurality of input/output areas, and for arranging an input/output unit that performs at least one of input and output of information relating to the product via the input/output area, wherein
the input/output unit is included in at least one of the arrangement areas.

According to the present invention, provided is a product information processing apparatus being used in a store where a product is purchased, and performing purchase processing of a product, the product information processing apparatus including
an input/output unit that is oriented upward, and performs at least one of input and output of information relating to a product.

### Advantageous Effects of Invention

The present invention can facilitate handling of a product information processing apparatus for both a salesperson and a customer.

### BRIEF DESCRIPTION OF DRAWINGS

The above-described object and other objects, features, and advantageous effects become more apparent from the preferred example embodiments described below and the following accompanying drawings.

FIG. 1 is a view illustrating a configuration of a product information processing apparatus according to a present example embodiment.

FIG. 2 is a view illustrating a modified example of FIG. 1.

FIG. 3 is a view illustrating a modified example of FIG. 1.

FIG. 4 is a view illustrating a modified example of FIG. 1.

FIG. 5 is a plan view illustrating a configuration of a product information processing apparatus according to a modified example 1.

FIG. 6 is a perspective view of a product information processing apparatus according to a modified example 2.

FIG. 7 is a view illustrating a configuration of a product information processing apparatus according to a second example embodiment.

FIG. 8 is a view illustrating a configuration of a product information processing apparatus according to a third example embodiment.

FIG. 9 is a view illustrating a configuration of a product information processing apparatus according to a modified example of FIG. 8.

FIG. 10 is a view of the product information processing apparatus illustrated in FIG. 9 as seen from a lateral face.

### DESCRIPTION OF EMBODIMENTS

Hereinafter, example embodiments of the present invention will be described by using the drawings. Note that, a similar component is assigned with a similar reference sign throughout all the drawings, and description therefor will be omitted as appropriate.

### First Example Embodiment

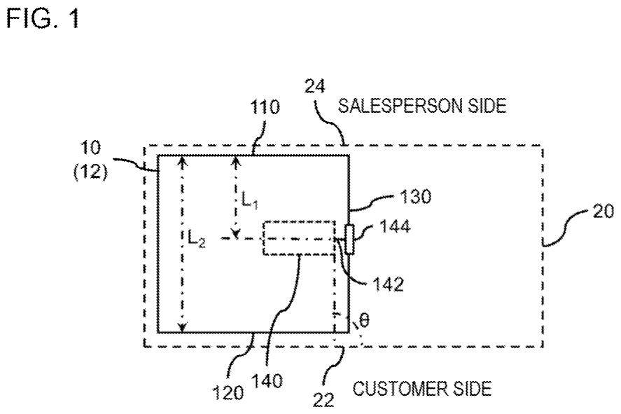

FIG. 1 is a view illustrating a configuration of a product information processing apparatus 10 according to a present example embodiment. The figure is equivalent to a view (a planar view) of the product information processing apparatus 10 as seen from above. The product information processing apparatus 10 is an apparatus for use in a store, and includes, for example, at least one of a product registration function and a settlement function. For example, the product information processing apparatus 10 may be an apparatus for a salesperson to perform both registration and settlement of a product, may be an apparatus for a customer to perform both registration and settlement of a product, may be an apparatus for a salesperson to perform registration of a product, or may be an apparatus for a customer to perform settlement.

The product information processing apparatus 10 is used while being arranged between a salesperson who performs purchase processing of a product and a customer who purchases the product. In an example illustrated in the present figure, the product information processing apparatus 10 is placed on a support member 20 for purchasing a product. The support member 20 is, for example, a counter. The salesperson and the customer are opposed to each other with the support member 20 interposed therebetween. The product information processing apparatus 10 includes an input/output unit 140. The input/output unit 140 performs at least one of input and output of information relating to a product. In addition, the input/output unit 140 is oriented in a direction different from the salesperson and the customer in planar view. Thus, the input/output unit 140 is easy to handle for both the customer and the salesperson.

In an example illustrated in the present figure, the product information processing apparatus 10 includes a housing 12. The housing 12 includes, on lateral faces thereof, a first area 110 opposed to the salesperson, a second area 120 opposed to the customer, and a third area 130 positioned between the first area 110 and the second area 120. In addition, the input/output unit 140 is provided inside the housing 12. The input/output unit 140 is opposed to the third area 130 from inside the housing 12.

The input/output unit 140 includes, for example, a printing apparatus printing a receipt and/or a coupon or the like, or an information reading apparatus reading information from a product. The information reading apparatus reads information determining a product to be sold from the product. The information reading apparatus may be, for example, a code reader reading a barcode or a two-dimensional code, or may be an image capture apparatus capturing an image of a product. In a former case, the product information processing apparatus 10 determines a product to be sold by using a code (for example, a JAN code or an EAN code) allotted to a product. In a latter case, the product information processing apparatus 10 determines a product to be sold by using appearance information (for example, an image) of a product.

In an example illustrated in the present figure, the input/output unit 140 includes an input/output face 142 on which input/output of information is performed. In addition, the third area 130 of the housing 12 includes an input/output area 144 on an area opposed to the input/output face 142. The input/output area 144 is an area for the input/output unit 140 to read information from outside of the housing 12, or an area for the input/output unit 140 to output information to outside of the housing 12. When the input/output unit 140 is a printing apparatus, the input/output area 144 is an opening for performing paper ejection. Further, when the input/output unit 140 is an information reading apparatus, the input/output area 144 is a window through which an electromagnetic wave such as light (including outside of a visible region, such as infrared) is transmitted.

The support member 20 includes a first side 22 and a second side 24 in planar view. The first side 22 is opposed to the customer, and the second side 24 is opposed to the salesperson. In an example illustrated in the present figure, the first side 22 and the second side 24 are substantially parallel to each other. In addition, an angle θ formed by the first side 22 and the input/output face 142 (or the input/output area 144) of the input/output unit 140 is, for example, 60° to 120° inclusive, and, furthermore, 80° to 100° inclusive. When the first side 22 and the second side 24 are parallel, an angle formed by the second side 24 and the input/output face 142 is also, for example, 60° to 120° inclusive, and, furthermore, 80° to 100° inclusive.

In an example illustrated in the present figure, the housing 12 includes four or more lateral faces. In addition, the first area 110 is a lateral face opposed to the salesperson, the second area 120 is a lateral face opposed to the customer, and the third area 130 is a lateral face positioned between the two lateral faces.

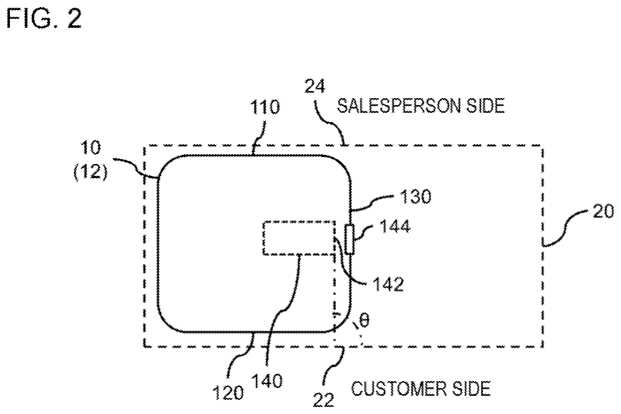

Note that, a boundary between the lateral faces may be a curved line in planar view, as illustrated in FIG. 2. In this case, any of the first area 110, the second area 120, and the third area 130 is an area of a lateral face different from a curved portion as a boundary.

Further, in an example illustrated in FIGS. 1 and 2, the input/output unit 140 is positioned in a middle between the first area 110 and the second area 120 or in a vicinity thereof, in a direction connecting between the first area 110 and the second area 120 (that is, between the salesperson and the customer). As one example, a distance L₁ from the first area 110 to a center of the input/output unit 140 (or the input/output area 144) is 40% to 60% inclusive of a space L₂ between the first area 110 and the second area 120.

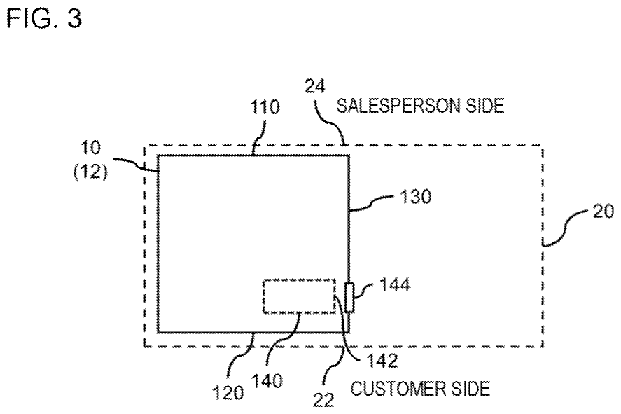

However, the input/output unit 140 may be positioned closer to the second area 120 than to the first area 110, as illustrated in FIG. 3. As one example, the above-described distance L₁ is over 60% of the above-described space L₂. Such a layout is preferred, for example, when the input/output unit 140 is an information reading apparatus and an information reading apparatus (including a case of a handy scanner) for the salesperson is provided on the first area 110 of the product information processing apparatus 10.

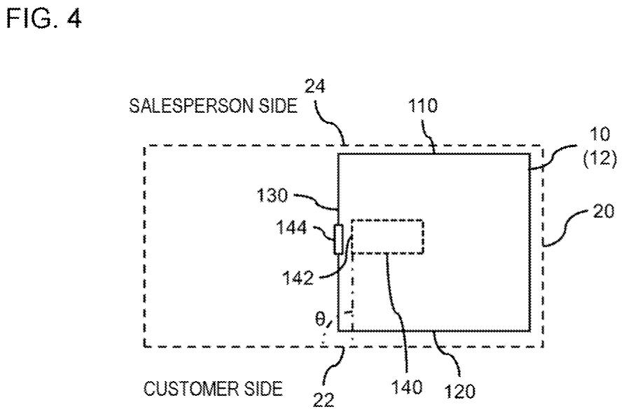

Further, in an example illustrated in FIGS. 1 to 3, the input/output unit 140 of the product information processing apparatus 10 is oriented rightward relative to the customer. This is because a product is placed on an area of the support member 20 on a right side of the product information processing apparatus 10. However, the input/output unit 140 of the product information processing apparatus 10 may be oriented leftward relative to the customer, as illustrated in FIG. 4. In this case, a product is supposed to be placed on an area of the support member 20 on a left side of the product information processing apparatus 10.

### Modified Example 1

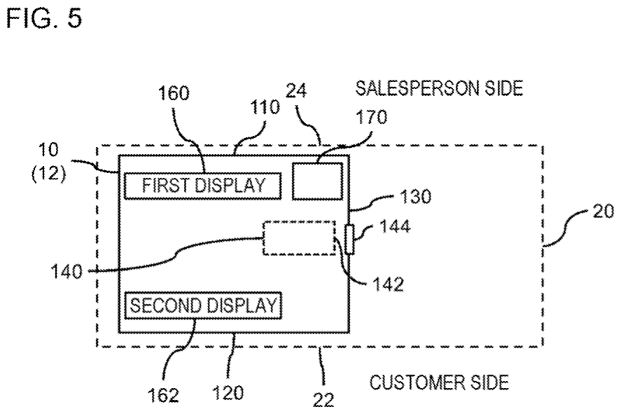

FIG. 5 is a plan view illustrating a configuration of a product information processing apparatus 10 according to a modified example 1. The product information processing apparatus 10 according to the present modified example is similar to the product information processing apparatus 10 according to the example embodiment except a following point.

First, the product information processing apparatus 10 includes a first display 160 and a second display 162. The first display 160 and the second display 162 may be a touch panel. The first display 160 is oriented to a salesperson side, and the second display 162 is oriented to a customer side. In other words, the first display 160 and the second display 162 are oriented opposite from each other. In addition, an orientation of an input/output face 142 of an input/output unit 140 is 60° to 120° inclusive, and, preferably, 70° to 110° inclusive, with a display face of the first display 160 as a reference.

Further, the product information processing apparatus 10 includes a handy-type information reading apparatus 170. The information reading apparatus 170 is positioned, for example, beside the first display 160.

### Modified Example 2

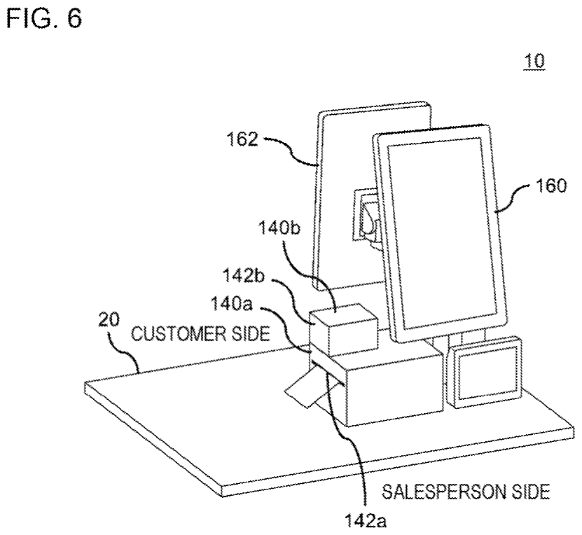

FIG. 6 is a perspective view of a product information processing apparatus according to a present modified example. The present modified example is similar to the modified example 1 except a following point.

First, the product information processing apparatus 10 does not include a housing 12. In addition, the product information processing apparatus 10 includes an input/output unit 140a as a printing apparatus and an input/output unit 140b as an information reading apparatus. The input/output unit 140b is positioned upside the input/output unit 140a. In addition, a center of the input/output unit 140b is positioned closer to a customer than a center of the input/output unit 140a, in a width direction of a support member 20. An orientation of the input/output units 140a and 140b is similar to the above-described example embodiment.

Further, the product information processing apparatus 10 may include a placement member. The placement member is, for example, a tray-like member. Other function units (for example, the input/output units 140a and 140b, a first display 160, and a second display 162) of the product information processing apparatus 10 are placed on the placement member. The function units are preferably fixed to the placement member. In addition, a shape of the placement member is similar to a shape of the housing 12 according to the example embodiment in planar view. Further, an orientation of the input/output units 140a and 140b with the placement member as a reference is similar to an orientation of the input/output unit 140 with the housing 12 as a reference according to the example embodiment.

As described above, according to the present example embodiment and the modified examples 1 and 2, the input/output unit 140 of the product information processing apparatus 10 is oriented in a direction different from a salesperson and a customer. Thus, the input/output unit 140 is easy to handle for both a customer and a salesperson.

### Second Example Embodiment

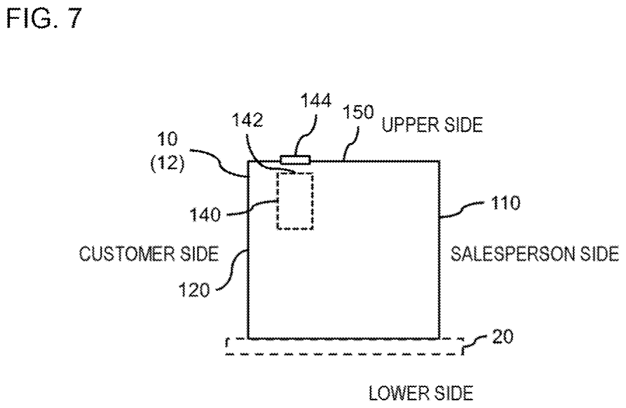

FIG. 7 is a view illustrating a configuration of a product information processing apparatus 10 according to a present example embodiment. The present figure is a view of the product information processing apparatus 10 as seen from a lateral direction. The product information processing apparatus 10 according to the present example embodiment is similar to the above-described example embodiment or the modified examples except a following point.

First, an input/output face 142 of an input/output unit 140 is oriented upward. In an example illustrated in the present figure, the input/output face 142 is opposed to a face (hereinafter, described as a top face 150) of the housing 12 oriented upward. In addition, an area of the top face 150 opposed to the input/output face 142 is an input/output area 144. Thus, the input/output unit 140 performs output of information toward above/or acquires information from above.

Note that, the housing 12 may include a portion positioned at a higher place than the top face 150. Further, the product information processing apparatus 10 may include an apparatus (for example, a touch panel or a handy scanner) positioned above the top face 150.

According to the present example embodiment as well, the input/output face 142 of the input/output unit 140 is oriented to an upper side. Therefore, the input/output unit 140 is easy to handle for both a customer and a salesperson.

### Third Example Embodiment

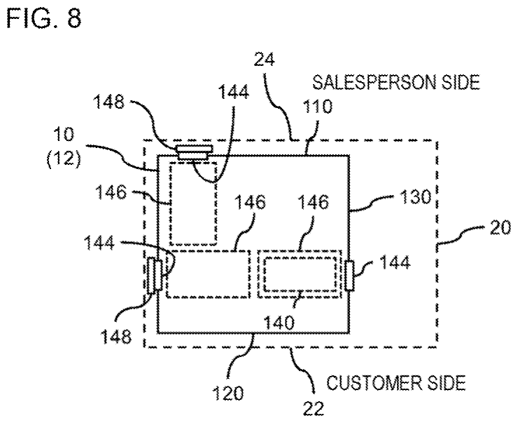

FIG. 8 is a view illustrating a configuration of a product information processing apparatus 10 according to a present example embodiment. The product information processing apparatus 10 according to the present example embodiment has a configuration similar to the product information processing apparatus 10 according to the first example embodiment except a following point.

First, a housing 12 of the product information processing apparatus 10 includes a plurality of input/output areas 144. The plurality of input/output areas 144 are oriented in mutually different orientations. In an example illustrated in the present figure, the input/output area 144 is provided on each of mutually different faces (for example, a face (a first area 110) opposed to a salesperson, a right-hand lateral face (for example, a third area 130) as seen from a customer, and a left-hand lateral face (for example, a lateral face on an opposite side of the third area 130) as seen from the customer) of the housing 12.

In addition, an arrangement area 146 is provided inside the housing 12 for each of the plurality of input/output areas 144. The arrangement area 146 is an area for arranging an input/output unit 140. In addition, the input/output unit 140 is provided, for example, in one arrangement area 146, and is not provided in remaining arrangement areas 146. Thus, the housing 12 of the product information processing apparatus 10 includes at least one empty arrangement area 146 while being used. Note that, another member may be arranged in the arrangement area 146 to be empty.

At least one arrangement area 146 may be connected to another arrangement area 146. In this case, a part of the arrangement area 146 overlaps with the another arrangement area 146. This can reduce a dead space inside the housing 12, although the input/output unit 140 cannot be arranged simultaneously in the two arrangement areas 146.

Note that, the input/output area 144 associated with the arrangement area 146 in which the input/output unit 140 is not provided is preferably covered by a covering part 148. The covering part 148 is, for example, a detachable lid (cover), and preferably has, for example, a color similar to the housing 12. This makes the unused input/output area 144 less noticeable, and thus, the salesperson and the customer can easily recognize which input/output area 144 is to be used.

### Modified Example

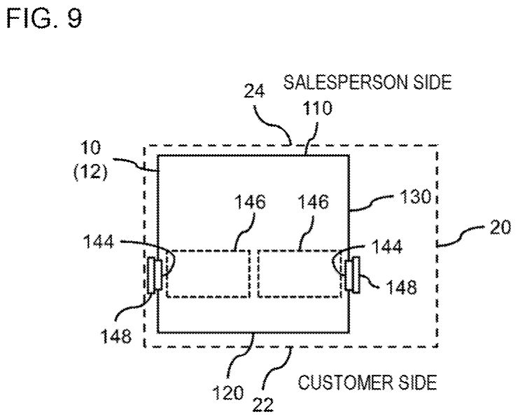

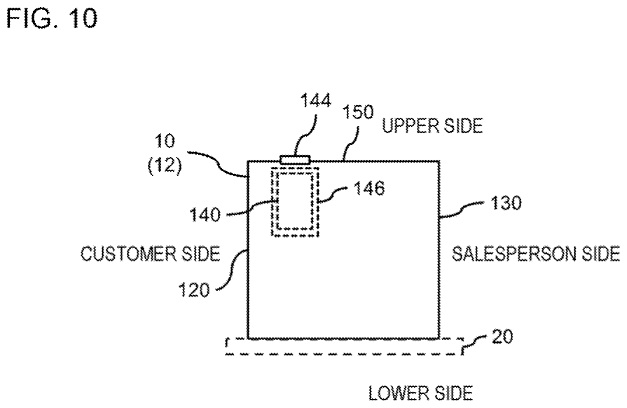

FIG. 9 is a view illustrating a configuration of a product information processing apparatus 10 according to a modified example of FIG. 8, and FIG. 10 is a view of the product information processing apparatus 10 illustrated in FIG. 9 as seen from a lateral face. In an example illustrated in the present figure, an input/output area 144 is provided on each of a right-hand lateral face (for example, a third area 130) and a left-hand lateral face of a housing 12 as seen from a customer, as illustrated in FIG. 9. Furthermore, the input/output area 144 is also provided on a top face 150 of the housing 12, as illustrated in FIG. 10. In addition, an arrangement area 146 is provided for each of the plurality of input/output areas 144.

According to the present example embodiment and the modified example, when the input/output unit 140 is installed in such a way as to be opposed to, for example, a right-hand lateral face as seen from a customer, a left-hand lateral face as seen from the customer, or the top face 150 of the housing 12, the input/output unit 140 becomes easy to handle for both the customer and a salesperson. Further, an orientation of the input/output unit 140 becomes easy to change. Furthermore, the input/output unit 140 can be also oriented to a salesperson side, and thus, the product information processing apparatus 10 has greater versatility.

While the example embodiments of the present invention have been described with reference to the drawings, the example embodiments are illustrative of the present invention, and various configurations other than the above can be employed.

The whole or part of the above-described example embodiments can be described as, but not limited to, the following supplementary notes.

1. A product information processing apparatus being installed in a store, being used in a state of being arranged between a salesperson who performs purchase processing of a product and a customer who purchases the product, and performing processing relating to purchase of a product, the product information processing apparatus including
an input/output unit that is oriented in a direction different from the salesperson and the customer in planar view, and performs at least one of input and output of information relating to a product.
   2. The product information processing apparatus according to supplementary note 1, wherein
the product information processing apparatus is arranged on a support member positioned between the customer and the salesperson,
the support member includes a first side opposed to the customer in planar view, and
the input/output unit has an orientation of the input/output unit of equal to or more than 60° and equal to or less than 120° relative to the first side.
   3. The product information processing apparatus according to supplementary note 1, further including
a first display opposed to the salesperson, wherein
the input/output unit has an orientation of the input/output unit of equal to or more than 60° and equal to or less than 120° relative to a display face of the first display in planar view.
   4. The product information processing apparatus according to supplementary note 1 or 2, further including
a housing including, on lateral faces thereof, a first area opposed to the salesperson, a second area opposed to the customer, and a third area between the first area and the second area, wherein
the input/output unit is opposed to the third area from inside.
   5. The product information processing apparatus according to supplementary note 4, wherein
the housing includes four or more lateral faces,
the first area and the second area are the two lateral faces opposed to each other, and
the third area is the lateral face positioned between the two lateral faces.
   6. The product information processing apparatus according to any one of supplementary notes 1 to 5, wherein
the input/output unit is a printing apparatus, and
a paper ejection port ejecting a printed material by the printing apparatus is oriented in a direction different from the salesperson and the customer.
   7. The product information processing apparatus according to any one of supplementary notes 1 to 5, wherein
the input/output unit is an information reading apparatus reading information from a product.
   8. The product information processing apparatus according to supplementary note 7, wherein
the information reading apparatus is closer to the customer than to the salesperson in a width direction connecting between the salesperson and the customer.
   9. A product information processing apparatus including:
a plurality of input/output areas being provided in order to perform at least one of input and output of information relating to a product, and including a transmission area through which an electromagnetic wave is transmitted or an opening; and
an arrangement area being provided in association with each of the plurality of input/output areas, and for arranging an input/output unit that performs at least one of input and output of information relating to the product via the input/output area, wherein
the input/output unit is included in at least one of the arrangement areas.
   10. The product information processing apparatus according to supplementary note 9, wherein
the product information processing apparatus includes a plurality of faces, and
at least two of the plurality of input/output areas are provided on mutually different faces.
   11. The product information processing apparatus according to supplementary note 9 or 10, further including
a covering unit that covers the input/output area in which the input/output unit is not provided.
   12. The product information processing apparatus according to any one of supplementary notes 9 to 11, wherein
the input/output unit is a printing apparatus, and
the input/output area includes the opening for ejecting a printed material of the printing apparatus.
   13. The product information processing apparatus according to any one of supplementary notes 9 to 12, wherein
the input/output unit is an information reading apparatus reading information from a product, and
the input/output area includes the transmission area.
   14. A product information processing apparatus being used in a store where a product is purchased, and performing purchase processing of a product, the product information processing apparatus including
an input/output unit that is oriented upward, and performs at least one of input and output of information relating to a product.
   15. The product information processing apparatus according to supplementary note 14, wherein
the input/output unit includes a printing apparatus, and
an opening for ejecting a printed material of the printing apparatus is oriented upward.

### REFERENCE SIGNS LIST

10 Product information processing apparatus
12 Housing
20 Support member
22 First side
24 Second side
110 First area
120 Second area
130 Third area
140 Input/output unit
142 Input/output face
144 Input/output area
146 Arrangement area
148 Covering part
150 Top face
160 First display
162 Second display
170 Information reading apparatus

What is claimed is:

1. A product information processing apparatus being installed in a store, being used in a state of being arranged between a salesperson who performs purchase processing of a product and a customer who purchases the product, and performing processing relating to purchase of a product, the product information processing apparatus comprising
an input/output unit is oriented in a direction different from the salesperson and the customer in planar view, and performs at least one of input and output of information relating to a product.

2. The product information processing apparatus according to claim 1, wherein
the product information processing apparatus is arranged on a support member positioned between the customer and the salesperson,
the support member includes a first side opposed to the customer in planar view, and
an orientation of the input/output unit is equal to or more than 60° and equal to or less than 120° relative to the first side.

3. The product information processing apparatus according to claim 1, further comprising
a first display opposed to the salesperson, wherein
an orientation of the input/output unit is equal to or more than 60° and equal to or less than 120° relative to a display face of the first display in planar view.

4. The product information processing apparatus according to claim 1, further comprising
a housing including, on lateral faces thereof, a first area opposed to the salesperson, a second area opposed to the customer, and a third area between the first area and the second area, wherein
the input/output unit is opposed to the third area from inside.

5. The product information processing apparatus according to claim 4, wherein
the housing includes four or more lateral faces,
the first area and the second area are the two lateral faces opposed to each other, and
the third area is the lateral face positioned between the two lateral faces.

6. The product information processing apparatus according to claim 1, wherein
the input/output unit is an information reading apparatus reading information from a product, and
the information reading apparatus is closer to the customer than to the salesperson in a width direction connecting between the salesperson and the customer.

7. A product information processing apparatus comprising:
a plurality of input/output areas being provided in order to perform at least one of input and output of information relating to a product, and including a transmission area through which an electromagnetic wave is transmitted or an opening; and
an arrangement area being provided in association with each of the plurality of input/output areas, and for arranging an input/output unit that performs at least one of input and output of information relating to the product via the input/output area, wherein
the input/output unit is included in at least one of the arrangement areas.

8. The product information processing apparatus according to claim 7, wherein
the product information processing apparatus includes a plurality of faces, and
at least two of the plurality of input/output areas are provided on mutually different faces.

9. The product information processing apparatus according to claim 7, further comprising
a covering unit that covers the input/output area in which the input/output unit is not provided.

10. A product information processing apparatus being used in a store where a product is purchased, and performing purchase processing of a product, the product information processing apparatus comprising
an input/output unit that is oriented upward, and performs at least one of input and output of information relating to a product.
